(19) United States
(12) Patent Application Publication
(10) Pub. No.: US 2014/0247347 A1
(43) Pub. Date: Sep. 4, 2014

(54) Methods and Apparatus for Video Based Process Monitoring and Control

(71) Applicants: Matthew C. McNeill, Milwaukee, WI (US); Francis J. Cusack, JR., Raleigh, NC (US); James Boerger, Racine, WI (US)

(72) Inventors: Matthew C. McNeill, Milwaukee, WI (US); Francis J. Cusack, JR., Raleigh, NC (US); James Boerger, Racine, WI (US)

(21) Appl. No.: 14/196,858

(22) Filed: Mar. 4, 2014

Related U.S. Application Data
(60) Provisional application No. 61/772,500, filed on Mar. 4, 2013.

(51) Int. Cl. G06T 7/00; H04N 7/18

(52) U.S. Cl. CPC G06T 7/004; H04N 7/18
USPC 348/143; 382/103

(57) ABSTRACT

Methods and apparatus for video based process monitoring and control are disclosed. An example method for monitoring a process having at least one state includes obtaining a first set of images of the process and identifying from the first set of images at least one reference image that corresponds to the at least one state. The example method also includes obtaining at least one analysis image of the process. The example method further includes comparing the analysis image to the at least one reference image using digital analysis. The example method also includes determining whether the analysis image corresponds to the at least one state based on the comparison.

### FIELD OF THE DISCLOSURE

This patent generally pertains to the monitoring of processes and control and more specifically to methods and apparatus for video based process monitoring and control.

### BACKGROUND

Video analytics is a known practice of using computers and software for evaluating video images of an area to determine information about the scene. Video analytics has a broad range of applications, such as security surveillance, face recognition, computer video games, traffic monitoring and license plate recognition.

Video analytics has been successfully used for recognizing body movements of players engaged in camera-based computer games. Examples of such games are provided by Nintendo Co., Ltd., of Kyoto, Japan; Sony Computer Entertainment, Inc., of Tokyo, Japan; and Microsoft Corp., of Redmond Wash.

In the field of security surveillance, video analytics can be used for determining whether an individual enters or leaves a camera's field of view. When combined with face recognition software, video analytics can identify specific individuals. Examples of face recognition software include Google's Picasa, Sony's Picture Motion Browser and Windows Live. OpenBR, accessible through openbiometrics.org, is an example open source face recognition system.

### BRIEF DESCRIPTION OF THE DRAWINGS

FIG. 1 is a schematic view of an example video based process monitoring method applied to an example machine in accordance with the teachings disclosed herein.

FIG. 1A is a more detailed system-level diagram of the example video system of FIG. 1.

FIG. 1B is a diagram of another example video system constructed in accordance with the teachings disclosed herein

FIG. 2 is a schematic view of the example machine shown in FIG. 1 but with the example machine experiencing an example pre-jam event.

FIG. 3 is a schematic view of the example machine shown in FIG. 1 but with the example machine experiencing an example jam event of a first predetermined type.

FIG. 4 is a schematic view of the example machine shown in FIG. 1 but with the example machine experiencing an example jam event of a second predetermined type.

FIG. 5 is a schematic view of the example machine shown in FIG. 1 but with the example machine experiencing an example jam event of greater severity than the example jam events shown in FIGS. 3 and 4.

FIG. 6 is a schematic view of another example jam detection method applied to another example machine in accordance with the teachings disclosed herein.

FIG. 7 is a flowchart representative of example machine readable instructions which may be executed to implement the example video system of FIG. 1B.

FIG. 8 is a flowchart representative of example machine readable instructions which may be executed to implement an example jam detection method in accordance with the teachings disclosed herein.

FIG. 9 is a flowchart representative of example machine readable instructions which may be executed to implement another example jam detection method in accordance with the teachings disclosed herein.

FIG. 10 is a flowchart representative of example machine readable instructions which may be executed to implement another example jam detection method in accordance with the teachings disclosed herein.

FIG. 11 is a flowchart representative of example machine readable instructions which may be executed to implement another example jam detection method in accordance with the teachings disclosed herein.

FIG. 12 is a flowchart representative of example machine readable instructions which may be executed to implement another example jam detection method in accordance with the teachings disclosed herein.

FIG. 13 is a flowchart representative of example machine readable instructions which may be executed to implement another example jam detection method in accordance with the teachings disclosed herein.

FIG. 14 is a block diagram of an example processor platform capable of executing the instructions of FIGS. 7-13 to implement the example systems of FIGS. 1-6.

FIGS. 15A-C illustrate an example environment having different arrangements of an accumulation of boxes to be detecting in accordance with the teachings disclosed herein.

FIGS. 16A-B illustrate the example environment of FIGS. 15A-C with different arrangement of the boxes having a higher density of accumulation.

FIGS. 17A-B illustrate the example environment of FIGS. 15A-C with different arrangement of the boxes having a lower density of accumulation.

FIGS. 18A-C illustrate an example environment in which the position of an example vehicle relative to a traffic lane and a walkway is to be detected in accordance with the teachings disclosed herein.

FIGS. 19A-C illustrate the example environment of FIGS. 18A-C with the example vehicle encroaching upon the walkway.

FIGS. 20A-C illustrate the example environment of FIGS. 18A-C with the example vehicle fully penetrating into the walkway.

### DETAILED DESCRIPTION

Many industrial and other processes can be characterized as having distinct states. In the examples herein, the term process is used broadly to include, for example, operation of a machine (including robotics), manual processes, movement of articles, vehicles or personnel, logistics flow within a machine, process or facility/grounds, etc. As one example, the movement of articles along a conveyor may have a first state such as a steady-state flow in which the articles move along the conveyor in a desired path or within a prescribed pathway or with one or more other desirable movement characteristics—spacing, orientation, speed, etc. The movement of articles along a conveyor, however, may also have other states. For example, an article may catch on a sidewall of the conveyor or other fixed structure and deviate from its desired path or move outside its prescribed pathway, perhaps ultimately leading to trailing articles getting jammed up behind the first article. The state of the process from when the first article deviates from its path until the actual jam occurs may be referred to as a second state of the process or flow, and the state in which the actual jam occurs may be referred to as a third process state. Transitions between states may themselves also be characterized as individual states. These various example states may be distinguishable based on a variety of characteristics, including being distinguishable using analysis of images or video (e.g., a sequential series of images) taken of the process. By capturing and analyzing images of the process—either real-time, near real-time, or otherwise—systems according to examples disclosed herein can identify when the process is in its different states and use that identification for a variety of purposes relative to the process being monitored. In many cases, a process being in a particular state—such as the state when the actual jam occurs, as referenced above—may be indicative of an event having occurred in the process. For the jamming example, the event may be the normally flowing article catching on the side wall, which event is the cause of the transition between the steady-state flow and, for example, the jam state. While there may be independent value in knowing which state the process is in, the state identification according to this disclosure can also have value as an indicator of different events having occurred in the process. It should be noted that an “event” may be a beneficial event, and not just a negative event such as a jam. For example, if the different states in a monitored process are an unfinished article and a finished article, the state identification disclosed herein can be used to determine that the article is in the finished state, and thus indicating that an event (for example, the last finishing step being performed on the article) has occurred.

The examples disclosed herein are not limited to detecting jam conditions. Indeed, a wide variety of industrial and/or other processes are characterized by states that are distinct from each other in a way that can be identified by image analysis. While the previous example dealt with individual articles being conveyed, the example image-based state identification can also be used for continuous material—such as a web of paper moving through a papermaking machine. In another example, the articles may be distinct, but may appear in some sense to be continuous—such as overlapping sheets of paper being conveyed. Moreover, the state identification methods are not limited to analysis of the conveyance of articles. Rather, any process, such as the examples disclosed herein, that is characterized by adequately distinguishable states can be analyzed according to the image-based state identification techniques disclosed herein. In another example, image analysis may be used to monitor vehicles, personnel, or other moving objects which may interface with or facilitate the flow of goods throughout a process and/or facility.

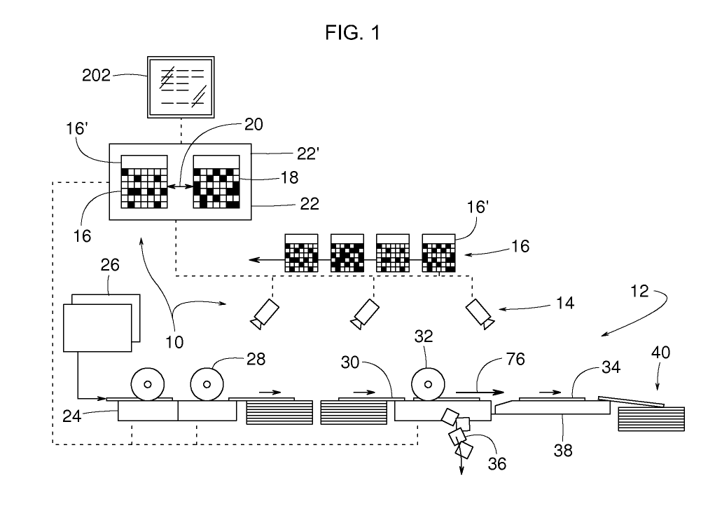

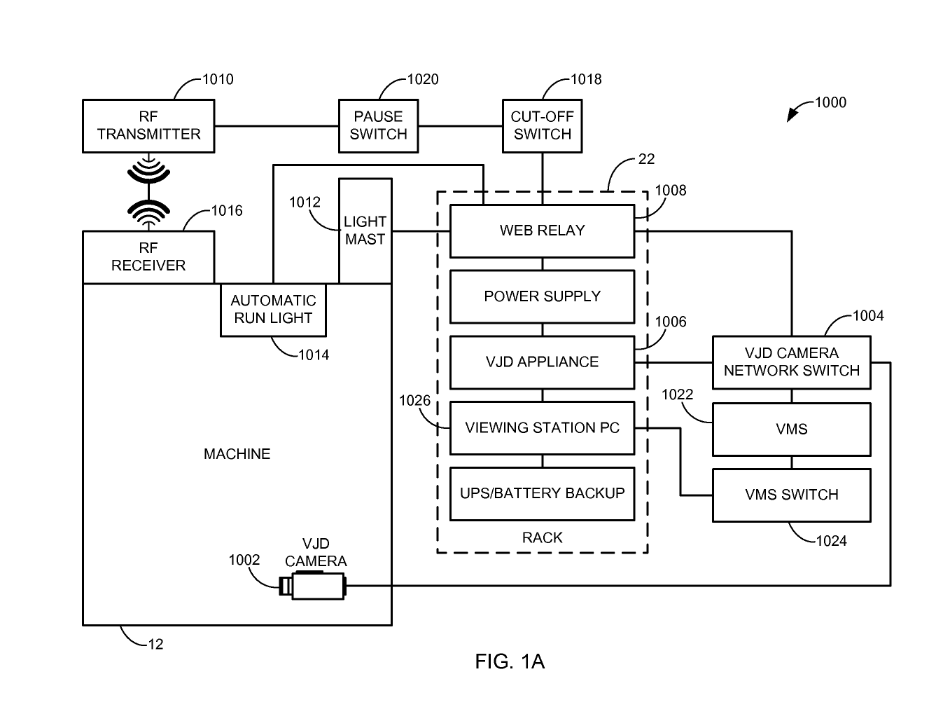

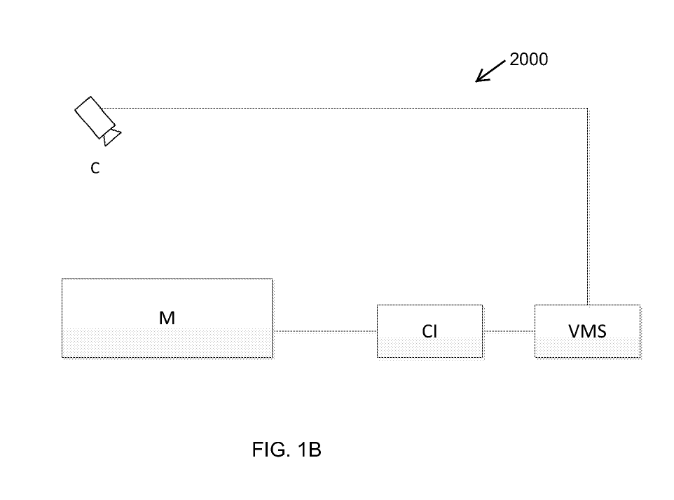

For purposes of illustration of image-based state identification, example jam detection methods and associated hardware are illustrated in FIGS. 1-14. The example methods use a camera or video system 10 for monitoring, analyzing and controlling the operation of a machine (e.g., a corrugated-paper-processing machine 12). In some examples, the camera system 10 comprises one or more video cameras 14 and video analytics for identifying one or more states and/or changes in state for a process or flow, such as distinguishing between a first state of the machine 12, such as a steady-state flow and a second state or states of the machine 12, such as a jam state or states, and/or a state or states of impending jam of the machine 12 or articles operated on by the machine. In the illustrated example, FIGS. 1-6 show cameras 14 capturing one or more analysis images 16 for comparison to a reference 18 comprising at least one other image. The term, “video analytics,” as used herein refers to an automatic process, typically involving firmware and/or software executed on computer hardware, for comparing the one or more analysis images 16 and/or its metadata 16′ to one or more reference images 18. Thus, video analytics includes the analysis of video (a series of images) as well as the analysis of individual images. With a degree of confidence depending on the circumstances, the resulting comparison 20 leads to a conclusion (or at least an estimation) as to which of several states of the process or flow that the machine 12 is in (e.g. steady-state flow, jamming or jammed), and thus the nature of an event that might have occurred with the machine 12 (e.g. improper handling of a sheet of corrugated paper, resulting in the jam). Examples of the comparison 20 include, but are not limited to, comparing pixels of one or more digital images to those of a reference digital image and/or comparing metadata, examples of which include, but are not limited to, contrast, grayscale, color, brightness, etc.

While the camera system 10 described herein is not limited to use of a specific video analytics algorithm to be run for the purpose of detecting a change in state (e.g. an occurrence relating to jamming or jams), a general description of representative examples of such video analytics will be provided. In some examples, to allow the resulting comparison 20 referenced above to be performed between one or more images 16 (and/or its metadata 16′) and one or more reference images 18 for the purpose of identifying the state that the process is in, those references must first be assembled. Recorded video can be used for this purpose. Accordingly, in some examples, video of the process to be monitored can be captured. In such examples, the video is then analyzed (for example by a human operator, or by a human operator with digital signal processing tools) to identify video frames or sequences representing examples of different states of the process. In the example of a corrugated-paper processing machine, these could be normal operation processing, empty machine, impending jam condition, and/or jam condition. In some examples, these images, once properly identified and categorized as examples of the various states, represent a “training set” that is then presented to the analytics logic (e.g., software). In this example, the “training set” is the “one or more reference images 18” referred to above. The analytics, in such examples, then uses a variety of signal-processing and/or other techniques to analyze the images and/or their associated metadata in the training set, and to “learn” the features associated with each state of the process. Once the analytics has “learned” the feature(s) of each machine state in this way, it is then capable of analyzing new images and, based on its training, assigning the new images to a given process state. In some examples, the field of view of the camera taking the images may be greater than the physical area of interest for the monitoring of the process. Accordingly, the analytics logic (e.g., software) may use the full frame of the image for learning and subsequently identifying the distinct process states based on that learning, or use only specific regions of a frame. In other examples, the field of view of the camera may be directed to a particular region of the physical area implementing the process (e.g., a particular stage of the process).

Since video analytics are often based on inference and probabilities, in some examples, the analytics assigns only a confidence level that a particular image represents a given process state. Even so, the ability for the analytics logic (e.g., software) to be trained to distinguish whether a given image represents a first state or a second (or more) state of the process or machine is dependent upon the ability to apply video analytics in the context of process monitoring, such as jam detection as described herein. In some examples, the assignment of a confidence level that a given image represents a given state may, in some cases, then allow the video analytics to draw a conclusion as to the nature of the event that might have occurred within the process and which resulted in the process being in the particular state.

Returning to the previous “jam detection” example, it should be noted that the analytics may not be limited to only detecting whether the machine is in only one type of jam state. Rather, in some examples, the analytics could be trained to not only identify that a given image represents the state of “jam” but could also be trained to distinguish different types of jams as different states. Again—so long as a set of training images can be assembled in which examples of the different states are present, and the states are capable of being distinguished from each other by video analytics techniques—analytics can be used that are capable of identifying a given image as corresponding to one of the states and with a confidence level. The ability of the video system to be able to identify different states (e.g., different types of jams), provides substantial benefits.

In some examples, once the video analytics have drawn a conclusion as to what state the operation of the process (e.g., implemented via the machine 12) is in, the video system 10 interacts with the monitored process, such as is being performed by the machine and takes appropriate action based on that conclusion. For instance, in some examples, if the video analytics determines that the machine 12 is in a jam state (defined below), the video system 10 interacts with the machine to interrupt the feeding of corrugated paper to prevent the jam from becoming more severe. Additionally or alternatively, in some examples, the video system 10 may alert an operator regarding the fact that the machine has been identified as being in a jam state. Further, in other examples, if the video analytics determines that a jam state is imminent (such as by being capable of determining that the machine is in an “impending jam” state), the video system 10 may adjust the speed and/or other operational functions of the machine and/or initiate any other suitable response.

The previous examples presumed that the video system 10 was analyzing the process real-time (or very close thereto) and also interacting with the process (e.g. communicating with the machine, notifying an operator) on an effective real-time basis. But the disclosed use of the results of the state identification analysis to interact with or control the process being monitored is not so limited. Once the analytics has “learned” how to distinguish between the various process states, this capability can be used to identify the state of the process in real-time or in an offline context where the analysis is not done contemporaneously with the running of the process. In that situation, the interaction of the video system with the process would also not be real-time. For example, the state identification may be used in an offline setting to create historical data about the process that can be analyzed to determine process improvements, or to measure the effect of already implemented process improvements.

In the example of a machine which is handling materials, the term, “jam state,” as used herein, refers to a deviation from a first state of the process being monitored, such as steady-state flow, which process is disrupted due to, for example, the machine mishandling an item The term, “item” refers to any article or part being processed, conveyed or otherwise handled by the machine, including one or more discrete item(s), a continuous item such as a web of paper, or overlapping contiguous items, as in this example with sheets of corrugated paper. The terms, “impending jam state” and/or “pre-jam state,” as used herein refer to a machine or process deviating from a state of normal operation (e.g., a steady-state flow), in a manner that is capable of being distinguished by the video analytics as a deviation from that normal state and which may lead to a jam state, yet still continuing to handle the item(s) effectively. Conveying an item in a prescribed manner means the item is being conveyed as intended for normal operation of the conveying mechanism/machine.

The term, “camera system,” as used herein, encompasses one or more cameras 14 and a computational device 22 that is executing image and/or video analytics logic (e.g., software) for analyzing an image or images captured by the one or more cameras. That is, in some examples, the one or more cameras 14 are video cameras to capture a stream of images. In some examples, the camera 14 and the computational device 22 share a common housing. In some examples, the camera 14 and the computational device 22 are in separate housings but are connected in signal communication with each other. In some examples, a first housing contains camera 14 and part of the computational device 22, and a second housing contains another part of the computational device 22. In some examples, the camera system 10 includes multiple cameras 14 on multiple machines 12. In some examples, the computational device 22 also includes a controller 22′ (e.g., a computer, a microprocessor, a programmable logic controller, etc.) for controlling at least some aspects of a machine (e.g., the machine 12) that is monitored or otherwise associated with the camera system 10. In other examples, the computational device 22 (or any other portion of the system, other than the camera itself) could be remotely located (e.g. via an internet connection).

A more detailed system-level diagram of the video system 10 is depicted in FIG. 1A. In the illustrated example, a VJD (Video Jam Detection) system 1000 includes a VJD camera 1002 is connected through a VJD Camera Network Switch 1004 to a VJD appliance that is running the video analytics (e.g., as part of the computational device 22). Images captured by the VJD camera 1002, in the illustrated example, are thus presented to the VJD appliance 1006 for evaluation to draw a conclusion as to which of several states the machine 12 is in—e.g., normal operational state, a jam state, a pre jam state, etc. In some examples, the evaluation and state identification of captured images is completed on a real-time, frame-by-frame basis. In the example system depicted in FIG. 1A, the analytics logic (e.g., software) is run in a separate VJD appliance, but other architectures are also possible—such as having a camera with adequate processing power on-board that the analytics could be run directly in the camera.

In some examples, the system 10 is capable of interacting with the machine 12 being monitored (in this example, a machine to process corrugated paper) to communicate and control the machine 12 based on the conclusion drawn by the VJD appliance 1006 as to which of several states the machine 12 is in—for example: interrupting the feed of corrugated paper to the machine 12 when the VJD appliance 1006 draws the conclusion that the machine 12 is in a jam state. For the purpose of such communication and control, in some examples, the VJD system 1000 includes a communications interface device such as a WebRelay 1008 which is connected through the VJD Camera Network Switch 1004 to the VJD appliance 1006. In some such examples, the WebRelay 1008 is an IP (internet protocol) addressable device with relays that can be controlled by other IP-capable devices, and inputs, the status of which can be communicated using an IP protocol to other devices. For machine control and communication purposes, the WebRelay 1008, of the illustrated example, is connected to an RF transmitter 1010, a light mast 1012, and/or an automatic run light 1014 on the machine 12. In such examples, the purpose of the RF transmitter 1010 is to signal the machine 12 to take action based on conclusions drawn by the VJD appliance 1006 as to the operational state of the machine 12. An RF receiver 1016 is included in some examples for communicating with the RF transmitter 1010. In such examples, the RF Receiver 1016 has been programmed to communicate with the machine 12 to cause a feed interrupt whenever the VJD appliance 1006 has determined that the machine 12 is in a jam state. Toward that end, in some examples, the VJD appliance 1006 may be programmed to control one of the relays in the WebRelay 1008 to cause the RF transmitter 1010 to transmit its RF signal whenever the VJD appliance 1006 determines that the machine is in a jam state. Similarly, to allow a visual indicator to be provided to a machine operator that the machine is in a jam state, in some examples, the WebRelay 1008 may also be connected to the light mast 1012 with, for example, visible red and green lights. In some examples, the VJD appliance 1006 may be programmed to control another of the relays of the WebRelay 1008 to switch the light mast 1012 from green to red whenever the VJD appliance 1006 determines that the machine is in a jam state. In other examples, the VJD system 1000 communicates with the machine 12 via a hardwire connection and/or any other communication medium.

Since it may be undesirable for the VJD appliance 1006 to be analyzing video to identify that operational state of the machine 12 when the machine 12 is in a non-operational state (since there is the possibility for false alarms in such a situation), in some examples, the system 1000 also includes communication from the machine 12 to the VJD appliance 1006 about its operational state. In such examples, the machine 12 has an automatic run light 1014 that is illuminated only when the machine 12 is in an operational state (e.g. actively feeding and processing corrugated paper). The signal from the automated run light, in some examples, is provided to one of the inputs of the WebRelay 1008. In some examples, the VJD appliance 1006 is programmed to periodically (e.g. 4 times per second) poll the WebRelay 1008 to determine the state of that WebRelay input. In such examples, the input going high indicates that the machine 12 is in an operational state, and that the VJD appliance 1006 should be performing state identification of the machine 12. Further, in some examples, when the input goes low, machine 12 is not operational, and the VJD appliance 1006 responds by suspending video analysis of the stream from the camera 1002. Additionally, in some examples, the VJD appliance 1006 may further be programmed to control the WebRelay 1008 to illuminate the light mast 1012 green whenever the machine 12 is operational and the VJD appliance 1006 is analyzing the video for the purpose of identifying the operational state of the machine 12

In some examples, to allow the action of the communication and control of the machine 12 to be suspended for any reason (e.g. malfunction of the VJD appliance 1006), a cut-off switch 1018 (for example a keyed-switch) may be placed in series between the WebRelay 1008 and the RF transmitter 1010 such that operation of the switch 1018 would disable a signal from the WebRelay 1008 from reaching the RF Transmitter 1010. Additionally or alternatively, in some examples, a momentary contact “pause” switch 1020 may also be provided which would allow an operator to achieve the same “suspension” functionality, but only during the time the momentary contact switch 1020 is depressed.

To facilitate video-based review of the operation of the machine 12, and particularly the review of specific machine or process states, such as jam states, in some examples, the VJD camera 1002 may also be connected through the VJD Camera Network Switch 1004 to a video recording device such as a standalone Video Management System (VMS) 1022 as shown in the illustrated example of FIG. 1A. In turn, the VMS 1022, in such examples, is connected through another switch (a VMS switch 1024) to a PC Viewing Station 1026, preferably located adjacent the machine 12. In some examples, the VMS 1022 is also in signal communication with the VJD appliance 1006 through the VJD Camera Network Switch 1004. The VMS 1022, in some examples, is configured to record the video stream emanating from the VJD Camera 1002, and includes a user interface that allows an operator to use a computer (e.g., the PC Viewing Station 1026) to review the recorded video to evaluate, for example, the operation of the machine 12. In some examples, an operator or other individual could also access the recorded video from a remote location using, for example, the internet.

In some examples, to facilitate review by an operator, and for other purposes, the VJD appliance 1006 is configured to communicate with the VMS 1022 to log identification information related to the machine state that has been performed by the VJD appliance 1006. For example, when the VJD appliance 1006 determines that the machine 12 has entered a jam state, the VJD appliance 1006 not only controls the WebRelay 1008 to initiate a feed interrupt in the machine 12, but also sends a “Jam Detected” signal to the VMS 1022. In such examples, the VMS 1022 is configured to receive this “Jam Detected” signal and create an entry in an event log associated with the recorded video from the VJD Camera 1002. As one example of performing this operation, the VJD appliance 1006 is programmed to send both the “Jam Detected” signal and the frame number of the frame identified as being indicative of the onset or beginning of the jam state. In such examples, the VMS 1022 is similarly programmed to tag that frame as representing a jam. Since a jammed condition of the machine 12 will typically extend over time, the VMS 1022 is programmed to create an entry in an event log comprising not only the tagged “jam” frame, but also frames both before and after that tagged frame—for example 5 seconds worth of frames on either side of the tagged frame. At a future time, in some examples, an operator of the machine 12 (or anyone else) can access the VMS 1022 (for example through the PC Viewing Station 1026) and use the event log to position the recorded video at the timestamp (e.g., the tagged frame) of a given jam event (resulting in a jam state for the machine 12), thereby allowing review of the jam event and the surrounding time period (e.g., a 10 second window). In some examples, this review may be beneficial to the operator, in that understanding the nature of the jam event through video-based review thereof (because he may not have been looking at the machine when the jam occurred) may allow the operator to diagnose the cause of the jam, and/or to make adjustments to the machine 12 that would reduce the likelihood of or prevent the same or a similar jam event from occurring in the future. The event logging capability in such examples is also beneficial in that logged events (e.g. jams detected by the VJD appliance 1006) corresponding to changes in the operational state of the machine 12 can easily be extracted from the VMS 1022 (since they all reside on an event list associated with the recorded video). In some examples, these extracted events may be useful in providing what could be referred to as a feedback path to the video analytics logic (e.g., software) running on the VJD appliance 1006, to allow continuing enhancement of the video analytics (for example by further training the software on jam events).

Additionally or alternatively, in other examples, the event logging capability of the VMS 1022 is used for other purposes. For example, the PC Viewing Station 1026 may be programmed with an interface that allows a machine operator (or others) to indicate when the VJD Appliance 1006 has created a false alarm by incorrectly indicating that machine 12 was in a jam state when it was not. By allowing the operator to indicate when a false alarm has occurred, in some examples, the VMS 1022 logs an event in the event list associated with the recorded video corresponding to the time of the false alarm indicated by the operator. In this manner, in some examples, a record of such false alarms (i.e. the analytics incorrectly identifying the machine 12 as being in a jam state) can be created. As is the case when the VJD appliance 1006 determines that the machine 12 is in a jam state, in some examples, video data of false alarms is extracted from the VMS 1022 by use of the event list to be used as a feedback path to the analytics running on the VJD appliance 1006, to reduce (e.g., minimize) false alarms generated in the future (for example by “retraining” the video analytics on the false alarms).

A similar regime can be applied to situations where a “missed detection” occurs. In some examples, operators may be provided with an interface on the PC Viewing Station 1026 that allows them to identify when the VJD appliance 1006 has missed a jam situation where the machine 12 was in a jam state. In some examples, in response to the identification by the operators of a missed jam detection, a “missed jam event” entry can be created on the VMS 1022 event list associated with the video stream. Accordingly, in some examples, the video playback capabilities of the VMS 1022 can then be used to locate the actual missed detections, and a selection of missed detections extracted for further training by the VJD analytics.

Both cases of: 1) allowing the identification and logging of “false alarms” and “missed jam detections” by an operator to assemble samples of such occurrences and 2) assembling “jam detection events” based on the automated tagging of such events in the VMS 1022, represent the concept of using human-based feedback on the operation and quality of the video analytics logic (e.g., software) running in the VJD Appliance 1006 to further enhance the capability of the analytics. Note that in the case of correct jam detections, the human-based feedback is the lack of an indication that the detection was a false alarm. In any event, providing a path for this human-based feedback allows the opportunity for improvement of the performance of the video analytics logic (e.g., software) over time. Indeed, as mentioned above, the initial development of the video analytics logic (e.g., software) is aided by human-based feedback—since the initial effect of assigning images to a given machine or process state is done by a human. Thus, there is benefit obtained both from having human judgment involved in creating the analytics, but also in providing human-based feedback to allow for continuous improvement of the logic. While any person could be properly trained to provide this judgment, using existing process experts may be beneficial. For the example of the machine 12 above, it would be desirable to have a trained machine operator assist in the process of associating images with various machine or process states for the purpose of building the initial analytics logic.

For that trained operator, or anyone else interested in improving the performance of a machine or process, the event logging in the recorded video is a valuable tool. Indeed, such functionality may be beneficial outside the context of using video analytics for determining the state or states of a process or machine operation. For example, the system 2000 shown in FIG. 1B comprises a camera C installed over a process or machine M being monitored, a video management system VMS (such as the VMS 1022 shown in FIG. 1A) for capturing and/or recording video and capable of an event logging function, and a communication interface CI between the VMS and the machine M. In some examples, the communication interface CI is capable of receiving signals from the machine itself, sensors located within the machine, and/or human input indicative of the status of machine operation. For example, to determine a jam condition in a machine, a photoeye sensor is commonly employed. The communication interface CI, in some examples, is in communication with the photoeye sensor, and receives a signal whenever the photoeye detects a jam. In some such examples, the interface CI, in turn, provides a “jam detected” signal to the VMS which corresponds to the machine being in a jam state, which creates an associated entry in an event log associated with the video being captured. Indeed, it is desirable to create an event tag in the video of not only video from the time of the event itself forward, but also backward to create an event window of video around the actual time when the machine was determined to be in a jam state. In this way, even without video analytics, an operator or other interested individual is able to access the event log in the VMS and review video of all of the jam events—perhaps being able to draw conclusions as to why jam events are occurring. This technique is not limited to jam events. So long as a signal is available regarding some aspect of machine operation, the communication interface CI can be used to capture that signal and communicate with the VMS to create an associated log entry. As above, while that signal may be from the machine or process itself, or a sensor associated therewith, in some examples, it could alternatively be a signal from an operator (pressing a button, clicking a menu on a computer screen, etc.) observing the machine operation or process.

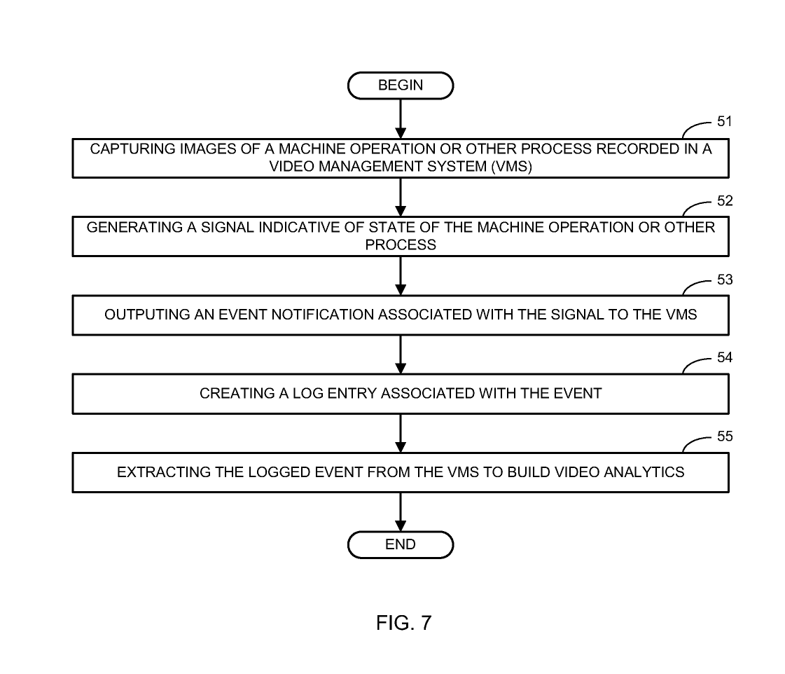

While this event logging capability is beneficial for reviewing machine or process operation and specific states thereof, it is also beneficial for creating video analytics logic to identify those specific states. To continue with the photoeye jam detection example from above—an event log is automatically created showing jams as detected by the photoeye. If it is desired to build a video analytics to detect jams, this event log is used to identify images associated with various machine states. Without this log, a human must review the “unfiltered” video to identify the relevant machine states—having to learn machine operation in the process. By using an existing signal from the machine (or an operator providing such a signal)—indicative of the very state for which analytics logic is to be built (a jam)—to create an event list in the recorded video, both the quality of the events, and the timeliness of assembling them will be enhanced. FIG. 7 depicts an example of this process. In the first block 51, a camera is capturing images of a machine operation or other process which are being recorded in a VMS. In the next block 52, a signal indicative of the state of the machine operation or the process is generated (by the machine itself, a sensor, or a human, etc.). In the following block 53, the signal is received by the communication interface which outputs an associated event notification to the VMS. In response, in block 54, the VMS creates a log entry associated with the event (preferably including both pre- and post-video). In the last block 55, the event log is extracted from the VMS and used for the purpose of building video analytics regarding the machine operation or process state of interest.

While the illustrated examples of FIGS. 1A and 1B show the VMS 1022 as being a standalone device (e.g., a general video surveillance system), accessed through an interface in the form of the PC Viewing Station 1026, the system design is not so limited. Just as it may be possible to locate the video analytics logic (e.g., software) remotely or on-board a camera with adequate processing capabilities, the same may also be true for the video storage, retrieval and event tagging capabilities of the VMS 1022—and all of these functions could reside on a camera or at a remote location (e.g., via the internet). Alternatively, in some examples, a computer appliance could be provided that is capable of both running the analytics and storing, retrieving and providing tagging of events in the video being analyzed. In short, the concept described herein is not limited to the specific architecture disclosed.

While an example manner of implementing the example camera system 10 of FIG. 1 is detailed in FIGS. 1A and 1B, one or more of the elements, processes and/or devices illustrated in FIGS. 1A and/or 1B may be combined, divided, re-arranged, omitted, eliminated and/or implemented in any other way. Further, the example VJD Camera Network Switch 1004, the example, VJD appliance 1006, the example, WebRelay 1008, the example, cut-off switch 1018, the example pause switch 1020, the example VMS 1022, the example VMS switch 1024, and/or, more generally the example VJD system 1000 illustrated in FIG. 1A may be implemented by hardware, software, firmware and/or any combination of hardware, software and/or firmware. Thus, for example, any of the example VJD Camera Network Switch 1004, the example VJD appliance 1006, the example WebRelay 1008, the example cut-off switch 1018, the example pause switch 1020, the example VMS 1022, the example VMS switch 1024 and/or, more generally, the example VJD system 1000 could be implemented by one or more analog or digital circuit(s), logic circuits (including relay logic), programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example VJD Camera Network Switch 1004, the example VJD appliance 1006, the example WebRelay 1008, the example cut-off switch 1018, the example pause switch 1020, the example VMS 1022, and/or the example VMS switch 1024 is/are hereby expressly defined to include a tangible computer readable storage device or storage disk such as a memory, a digital versatile disk (DVD), a compact disk (CD), a Blu-ray disk, etc. storing the software and/or firmware. Further still, the example VJD system 1000 of FIG. 1A may include one or more elements, processes and/or devices in addition to, or instead of, those illustrated in FIG. 1A, and/or may include more than one of any or all of the illustrated elements, processes and devices.

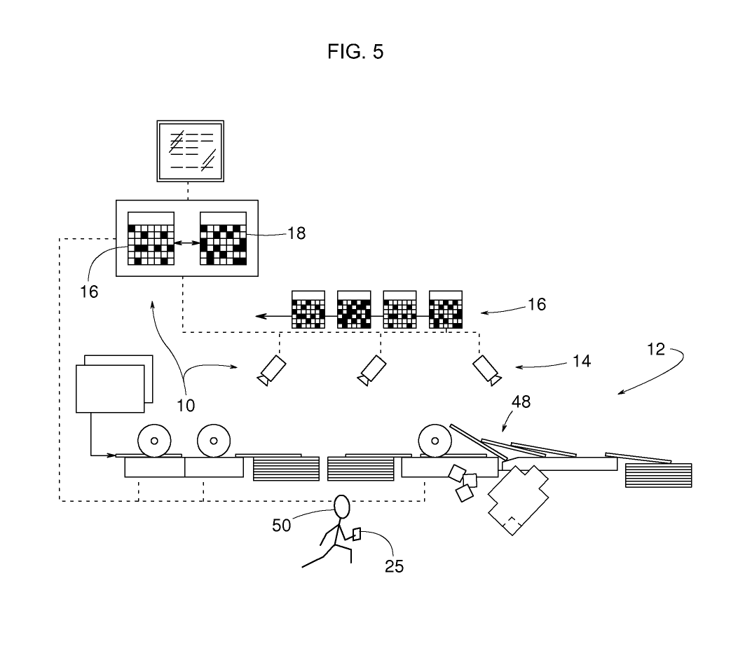

In addition to monitoring a machine process and performing image-based state identification such as jam detection, some example methods disclosed herein provide one or more additional functions. Examples of such additional functions include, but are not limited to, computing a level of confidence or likelihood that an image 16 represents the machine 12 being in a jam state; documenting individual states within a period of time associated with the determination of the machine 12 being in a jam state (jam commencement, machine downtime, service personnel response time, etc.) by tagging recorded video with information about the state determination made by the analytics; documenting the frequency of jams; disabling a machine while a person 50 (see FIG. 5) is actively clearing the jam; determining the severity of jams; determining whether a conveyed item left a prescribed path along a conveyor; automatically adjusting the machine's speed as a function of the jam severity or frequency of occurrence; automatically adjusting the machine's speed in response to detecting that the machine is in an impending jam or pre jam state; determining the type of jam; determining what caused a jam; determining the type or size of an item being processed and adjusting the machine's speed accordingly; video monitoring multiple machines and apportioning their workload based on a history of jams, part types and/or machine characteristics; and establishing wireless communication and control between a machine or process and a person 50 with a portable wireless communication device 25 (e.g., a smartphone, digital tablet, etc.; see FIG. 5).

Although example state identification methods such as jam detection methods disclosed herein can be used for a wide variety of equipment and processes, the example jam detection methods shown and described are provided in the context of corrugated paper-processing machines. FIGS. 1-6, for example, show a corrugated paper-processing machine or machine 12 comprising a corrugator 24 for corrugating raw sheets 26 and a gluer 28 for bonding layered sheets 26 to produce incoming sheets 30 that are fed to a cutting machine 32 (e.g., a rotary die cutter (RDC machine)). Cutting machine 32 cuts an incoming sheet 30 for creating a finished cut sheet 34 while discarding the resulting one or more scrap pieces 36. A conveyor 38 transfers cut sheet 34 to a collection area 40. In some examples, machine 12 comprises just cutting machine 32 and/or conveyor 38, and corrugator 24 and gluer 28 are separate machines, for example in another building. In some examples, only a single camera 14 is used for monitoring just one specific area of machine 12. One example of such a specific area is the area including cutting machine 32 and conveyor 38.

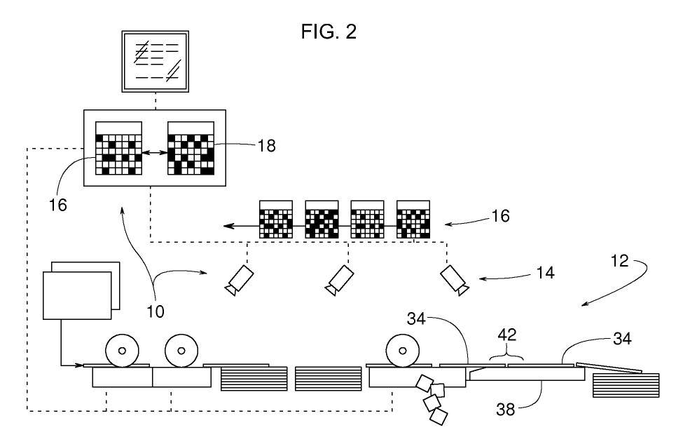

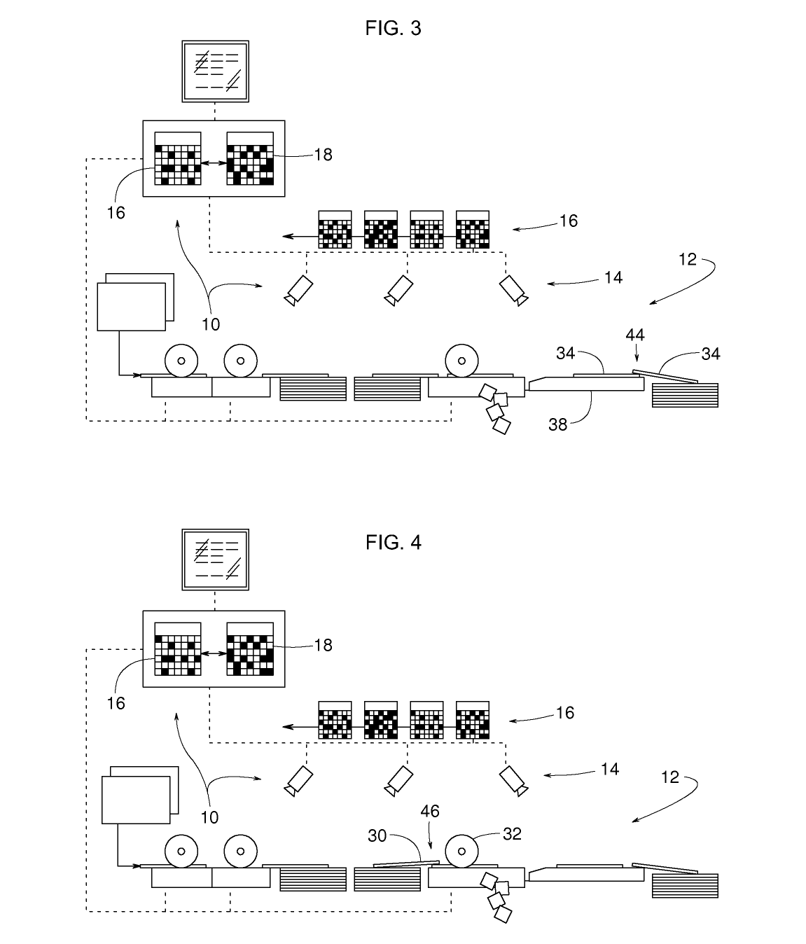

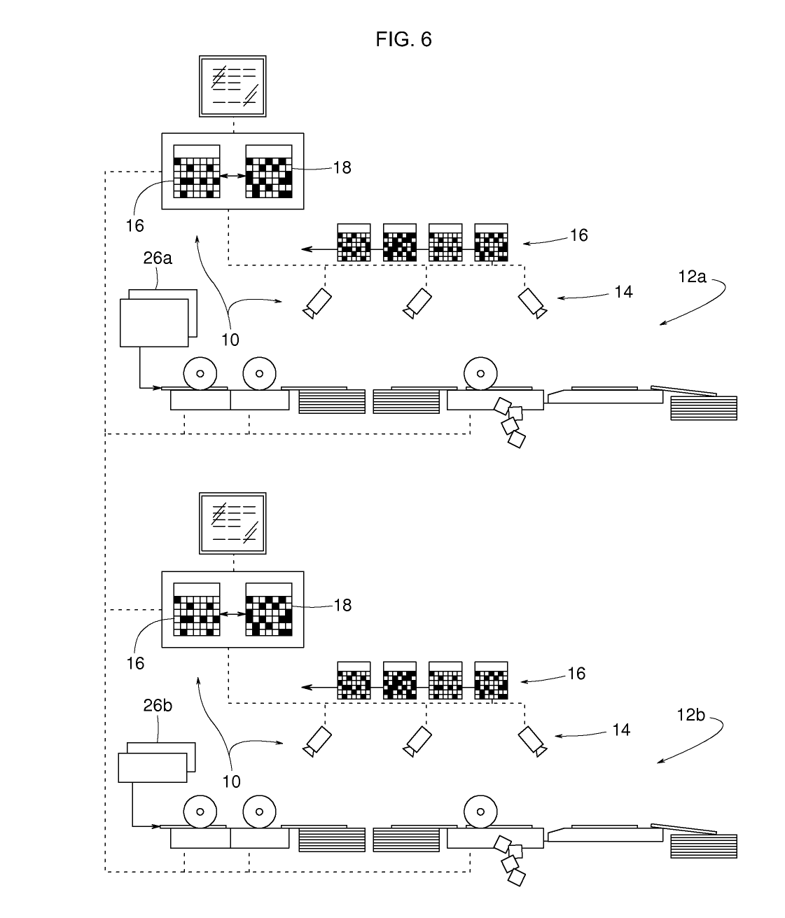

FIG. 1 shows machine 12 under normal operation—i.e. the process is in a first state such as a steady-state flow. FIG. 2 shows machine 12 and thus the process experiencing a second state, such as a pre-jam state 42 characterized by some congestion occurring with items (e.g., the cut sheets 34) on conveyor 38. FIG. 3 shows yet another (third) state in the form of a jam state of a predetermined first type 44, for example, where some items (e.g., the cut sheets 34) are overlapping on conveyor 38. FIG. 4 shows a fourth state in the form of a jam state of a predetermined second type 46, for example, where some items (e.g., the incoming sheets 30) are overlapping at the upstream end of cutting machine 32. FIG. 5 shows an additional (fifth) state in the form of a jam state 48 of a greater degree of severity than that shown in FIGS. 3 and 4. FIG. 5 also shows a person 50 dispatched for correcting jam state 48. FIG. 6 shows items 26a and 26b (which may be the same or different types of items) processed through two separate machines 12a and 12b.

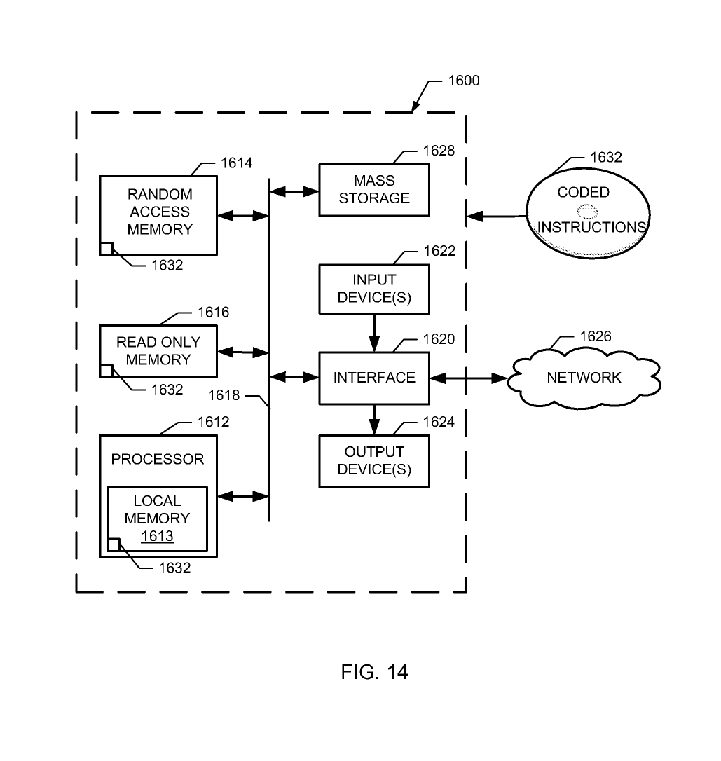

Flowcharts representative of example machine readable instructions for implementing the camera system 10 of FIGS. 1-6 are shown in FIGS. 7-13. In this example, the machine readable instructions comprise a program for execution by a processor such as the processor 1612 shown in the example processor platform 1600 discussed below in connection with FIG. 14. The program may be embodied in software stored on a tangible computer readable storage medium such as a CD-ROM, a floppy disk, a hard drive, a digital versatile disk (DVD), a Blu-ray disk, or a memory associated with the processor 1612, but the entire program and/or parts thereof could alternatively be executed by a device other than the processor 1612 and/or embodied in firmware or dedicated hardware. Further, although the example program is described with reference to the flowcharts illustrated in FIGS. 7-13, many other methods of implementing the example camera system 10 may alternatively be used. For example, the order of execution of the blocks may be changed, and/or some of the blocks described may be changed, eliminated, or combined.

As mentioned above, the example processes of FIGS. 7-13 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 7-13 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disk and to exclude propagating signals. As used herein, when the phrase “at least” is used as the transition term in a preamble of a claim, it is open-ended in the same manner as the term “comprising” is open ended.

Turning in detail to the figures, FIGS. 8-13 illustrate various example jam detection methods for the example machines or processes illustrated in one or more of FIGS. 1-6. FIG. 8, illustrates an example jam detection method in which image-based state identification is used to determine the state of a process, and controlling the process based on that state identification. The example involves the use of at least one of each of an incoming sheet 30, a cut sheet 34, a scrap piece 36, a cutting machine 32 (e.g., a RDC) of a machine 12 and a camera system 10 (see FIGS. 1-6), wherein block 56 represents operating the machine 12 according to a prescribed normal operation (e.g., FIG. 1); block 57 represents feeding the incoming sheet 30 to the cutting machine 32; block 58 represents the cutting machine 32 cutting the incoming sheet 30 to create the cut sheet 34 and the scrap piece(s) 36; block 59 represents separating the scrap piece(s) 36 from the cut sheet 34; block 60 represents conveying the cut sheet 34 along a discharge path 76 leading away from the cutting machine 32 and, thus, a first state of machine operation or steady-state flow; block 62 represents the camera system 10 capturing a digital image 16 of the cut sheet 34 on the discharge path 76, wherein the digital image 16 is one of a plurality of digital images; block 66 represents computing a comparison 20 by comparing the digital image 16 to at least one reference image 18; and decision block 68 represents, based on the comparison 20, determining whether the digital image 16 indicates that the machine is still in its first state, or in a second state in which a jam has or will occur, wherein the jam state is defined as a condition where the cut sheet 34 relative to the discharge path 76 is sufficiently dislocated that disruption of the prescribed normal operation is at least imminent. If the result in decision block 68 is “yes” indicating that the machine is in a jam state, the method continues to block 70 which represents controlling the machine 12 based on a determination that the machine 12 is in a jam state (e.g., by inducing a feed interrupt to the machine 12). If the result in decision block 68 is “no”, the method returns to block 62 and the analysis continues.

Block 70 of FIG. 8, in which the camera system 10 controls the machine 12 based on image-based state identification of the machine 12 being in a jam state is an example of using the results of image-based state identification to control a process being monitored. In another example, the control may be indirect—such as the camera system 10 providing a notification to an operator when it determines that the machine is in a particular state, such as a jam state—thereby allowing the operator to take corrective action such as causing a feed interrupt to stop the operation of the machine 12. The notification could take a variety of forms, including sending a notification to a portable wireless communication device provided to the operator.

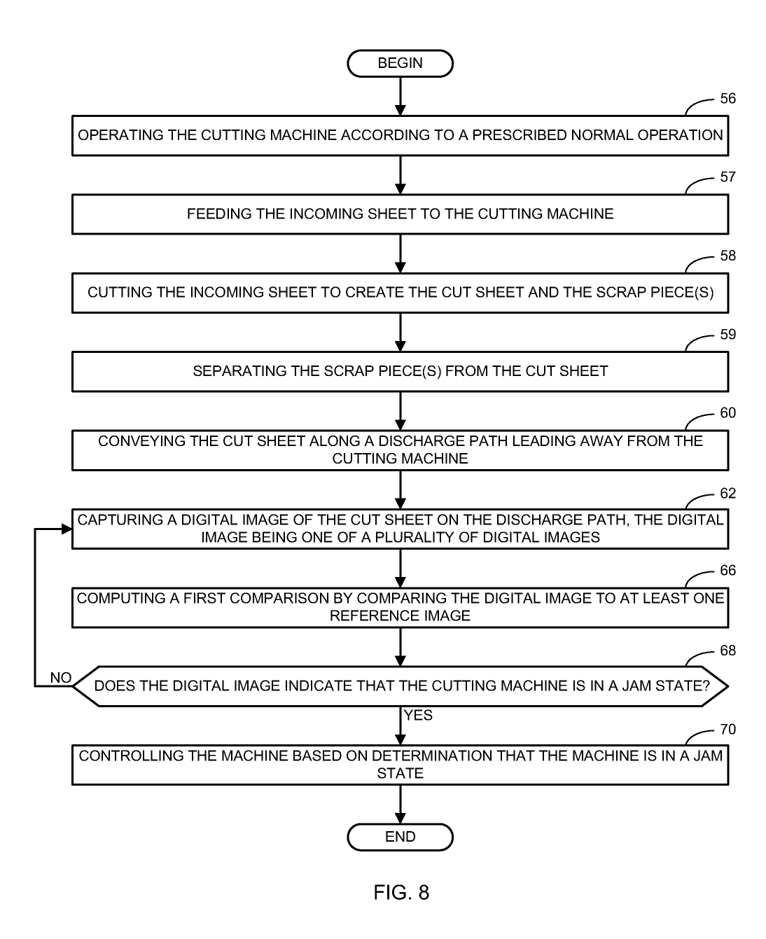

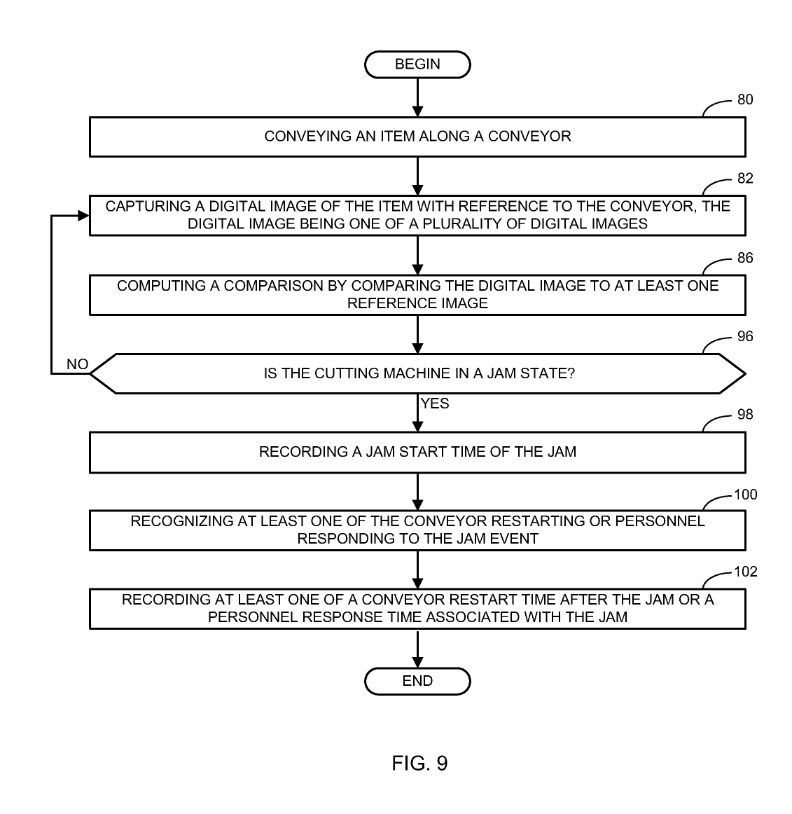

FIG. 9 illustrates an example jam detection method involving the use of at least one of each of an item (e.g., the cut sheet 34), a conveyor 38 of a machine 12, and a camera system 10, wherein block 80 represents the machine conveying the item 34 along the conveyor 38. Block 82 represents the camera system 10 capturing a digital image 16 of the item 34 with reference to the conveyor 38, wherein the digital image 16 is one of a plurality of digital images. Block 86 represents the camera system 10 computing a comparison 20 by comparing the digital image 16 to at least one reference image 18. Decision block 96 represents determining whether the process has deviated from the first or steady-state and is in a second state, such as a jam state, based on the comparison 20 (Block 86). If the result of the decision in block 98 is “yes” the method continues to block 98 which represents the camera system 10 recording a time associated with a given state, such as a jam start time of the jam corresponding to when the jam state was initially detected and/or when a feed interrupt is provided to the machine 12. If the result of the decision block 98 is “no” the method returns to block 82. Block 100 represents recognizing at least one of the conveyor 38 restarting (after the jam has been cleared and the machine 12 is ready to resume operation), or a person 50 responding to the jam. In some examples, characteristics of the captured image 16 may indicate the conveyor 38 restarting and/or the person 50 responding to the jam, thus defining additional states of the process which can be identified by the camera system 10. On the other hand, in some examples, other means could be used to determine when the conveyor 38 has restarted or the person 50 has responded to the jam. Regardless of the source of that time-based information, block 102 represents the camera system 10 recording a time associated with a given state, such as at least one of a conveyor restart time after the jam or a personnel response time associated with the jam. The personnel response time, in some examples, refers to the time of day the person 50 arrived at the jam, the time of day the person 50 left the machine after clearing the jam, and/or the length of time the person 50 attended to the jam.

This function of capturing times associated with given states of a process being monitored, and the event logging capabilities of the system as detailed above, provide a wealth of data regarding machine operation. For example, a time-stamped log of jams and actions associated with jams (personnel response time, conveyor restart time, etc.) can be analyzed to determine the frequency and/or severity of jams, as well as other operational information. Such information can then be used to improve machine operation. If, for example, jam frequency increases during a certain time of the day (e.g. second shift), this may be an indication that the second shift operators are not adjusting the machine properly—suggesting that retraining should be performed. In another example, analysis of the data reveals that jam frequency consistently increases two weeks after machine preventative maintenance, suggesting that the machine should be maintained more frequently.

Combining jam frequency data with information about the product being produced by the machine 12, or other machine settings can give even further insights. Knowing that Product A has a higher jam frequency over time than Product B can indicate that Product A should be run at a lower machine speed to reduce the tendency to jam—assuming that lower machine speed correlates to reduced jam frequency. Indeed, the jam frequency data could be used to explore that correlation with machine speed—if combined and analyzed with data about machine speed. Almost any parameter regarding the machine 12 and/or the products being produced by it can be combined and analyzed with the jam frequency data to look for correlations that can then be used to improve machine or product performance.

The same is also true for information about jam severity. As referenced above, the machine restart time may be captured by the disclosed system. By comparing machine restart time and the jam detection time (at which time a feed interrupt is provided to the machine 12), a “jam duration” can be calculated. This jam duration is an indication of the severity of the jam, as a more severe jam typically requires a longer time to be cleared from the machine before a machine restart can be performed. Being able to analyze this jam severity against other data is instructive. Analysis of machine parameters against the jam severity data may reveal that jam severity goes up when the machine is run above a certain speed—suggesting that the certain speed should represent a ceiling that should not be exceeded. Analysis of the product being produced against the jam severity data may reveal that Product A produces jams of greater severity than Product B—suggesting that operational parameters should be adjusted differently for Product A than Product B in an attempt to prevent the more severe jams.

Similar analysis can be done with the personnel response times. Higher response times may correlate with certain personnel—suggesting that their workload should be adjusted to allow for a faster response, or that some form of retraining is necessary. Higher response times could also correlate with certain products being produced by the machine 12. These higher response times could indicate that personnel are distracted by other aspects of running that product—suggesting perhaps that a re-engineering of that product or how it is run is desirable.

Another example of such jam-related data would be jam type identification as referenced earlier. Assuming that Jam Type A is caused by a problem in Section A of the machine 12, and that Jam Type B is caused by a problem in Section B, an increase in Type B jams could be indicative of a problem in Section B—suggesting that preventative maintenance be performed on that part of the machine. Similarly, if jam type data were combined and analyzed with data about the product being run, one could determine when a given product has a higher tendency to jam in a certain way relative to another product or products—and take appropriate corrective action when that given product is being processed. The same could also be true for machine operational settings. Combining and analyzing the jam type data with one or more of the machines operational settings (machine speed, belt tension, etc.) might reveal that a certain set of machine settings has a higher tendency to produce a particular kind of jam—suggesting that one or more of those settings be changed to prevent that type of jam from occurring.

As a general proposition, jam-related data (frequency, severity, response time, type of jam etc.) as a specific example of image based state identification data as disclosed herein, can beneficially be analyzed either on its own, or in combination with other operational parameters of the process or machine being monitored (machine speed, product being processed, personnel) to reveal aspects of the process that are not otherwise apparent.

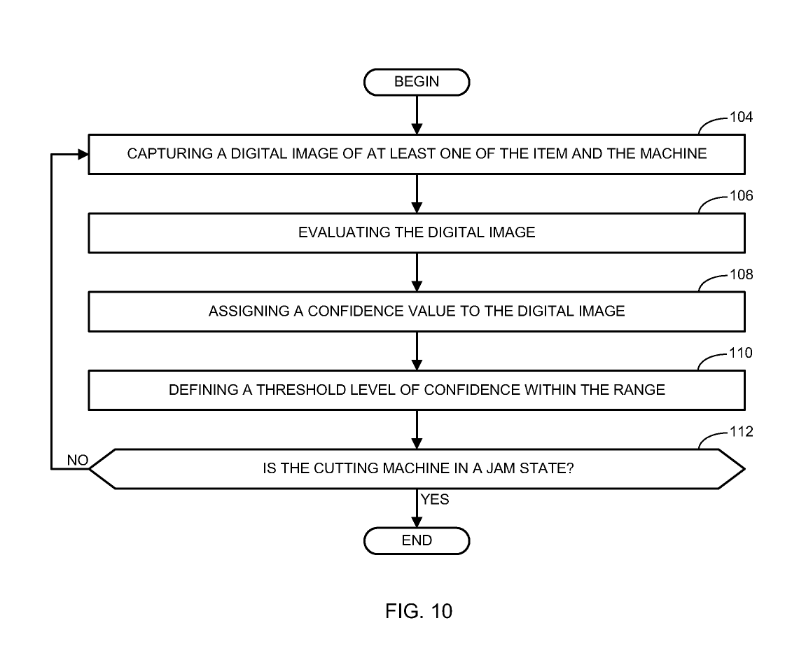

FIG. 10 illustrates an example jam detection method for machine 12, which might experience a jam while handling an item (e.g., the cut sheet 34). In this example, the jam detection method involves the use of a camera system 10, wherein block 104 represents the camera system 10 capturing a digital image 16 of the item 34 and/or a machine 12. Block 106 represents evaluating the digital image 16 via suitable video analytics. Block 108 represents assigning a confidence value to the digital image 16. In such examples, the confidence value reflects a level of confidence that the digital image 16 represents the machine 12 being in a jam state. The level of confidence is within a range of zero percent confidence to one hundred percent confidence that the digital image 16 represents a jam state. Block 110 represents defining a threshold level of confidence within the range of zero to one hundred percent (e.g., 75%). Decision block 112 represents determining whether the machine 12 experienced the jam (e.g., whether the machine 12 is in a jam state) based on whether the level of confidence reflected by the confidence value is between the threshold level of confidence and the one hundred percent confidence. If the result of decision block 112 is “yes” the method continues to the end. If the result of decision block 112 is no, the method returns to block 104.

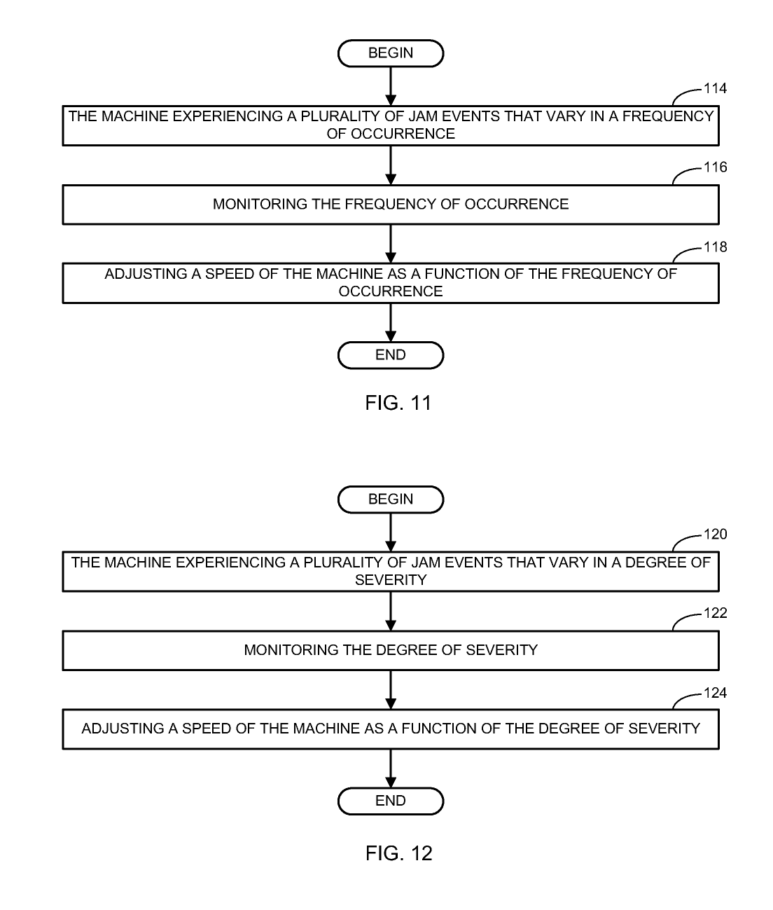

FIG. 11 illustrates a jam detection method in which the frequency of jams is used as an input parameter in controlling the operation of the machine that is jamming. Block 114 represents the machine 12 experiencing a plurality of jams that vary in a frequency of occurrence. Block 116 represents the camera system 10 monitoring the frequency of occurrence. Block 118 represents the camera system 10 adjusting the speed of the machine 12 as a function of the frequency of occurrence.

FIG. 12 illustrates a jam detection method in which the severity of jams is used as an input parameter in controlling the operation of the machine that is jamming. Block 120 represents the machine 12 experiencing a plurality of jams that vary in a degree of severity. The degree of severity of a jam may be determined, for example, by the time required for an operator to clean out the jam and/or reset the machine 12 for operation following the jam (e.g., the more time required the more severe the jam). Block 122 represents the camera system 10 monitoring the degree of severity, for example, by determining the time required for the operator to clean out the jam for each identified jam. For example, the analytics logic (e.g., software) could perform this function by using a “human recognition” algorithm to determine when an operator is in and/or by the machine performing clean-out operations—thus defining “man in machine” as another state of the process. Block 124 represents the camera system 10 adjusting the speed of the machine 12 as a function of the degree of severity.

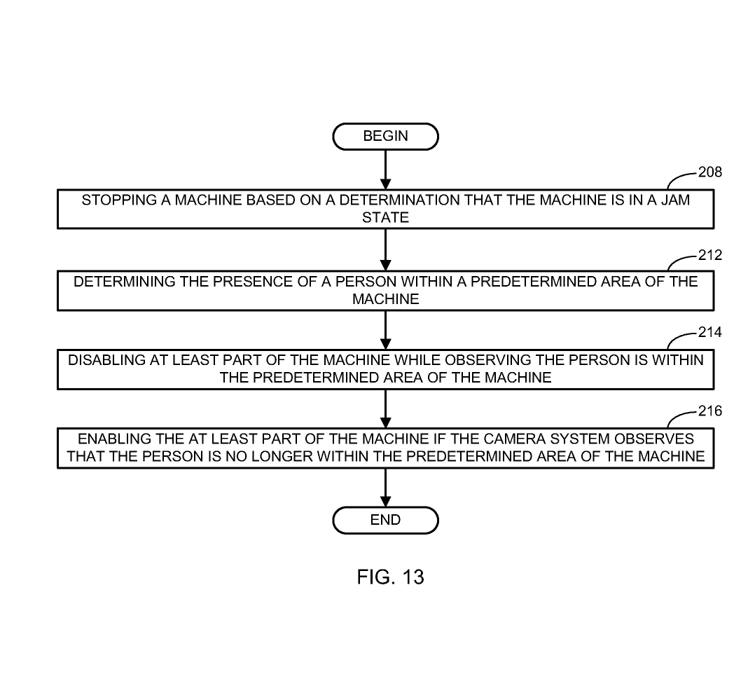

FIG. 13 illustrates an example jam detection method where machine 12 experiences a jam while handling an item (e.g., the cut sheet 34), and a person 50 later responding to and/or correcting the jam. In the illustrated example, block 208 represents the camera system 10 stopping the machine 12 based on a determination that the machine is in a jam state, for example by the method shown in FIG. 8. Block 212 represents the camera system 10 determining that a person 50 is within a particular area associated with the machine 12, such as an area where the person 50 would be present while clearing or correcting the jam. In some examples, the method specified in block 212 is achieved by comparing one or more captured images 16 to a reference image 18 and applying suitable video analytics, and thus a person being in the particular area associated with the machine is an additional process machine state that can be identified by camera system 10 using video analytics. Block 214 represents the camera system 10 disabling at least part of the machine 12 while observing that the person 50 is still within the area adjacent the machine 12. Block 216 represents the camera system 10 enabling at least part of the machine 12 if the camera system 10 observes that the person 50 is no longer within the area adjacent the machine 12.

FIG. 14 is a block diagram of an example processor platform 1600 capable of executing the instructions of FIGS. 7-13 to implement the camera system 10 of FIGS. 1-6. The processor platform 1600 can be, for example, a server, an Internet appliance, or any other type of computing device.

The processor platform 1600 of the illustrated example includes a processor 1612. The processor 1612 of the illustrated example is hardware. For example, the processor 1612 can be implemented by one or more integrated circuits, logic circuits, microprocessors or controllers from any desired family or manufacturer.

The processor 1612 of the illustrated example includes a local memory 1613 (e.g., a cache). The processor 1612 of the illustrated example is in communication with a main memory including a volatile memory 1614 and a non-volatile memory 1616 via a bus 1618. The volatile memory 1614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1616 may be implemented by flash memory and/or any other desired type of memory device. Access to the main memory 1614, 1616 is controlled by a memory controller.

The processor platform 1600 of the illustrated example also includes an interface circuit 1620. The interface circuit 1620 may be implemented by any type of interface standard, such as an Ethernet interface, a universal serial bus (USB), and/or a PCI express interface.

In the illustrated example, one or more input devices 1622 are connected to the interface circuit 1620. The input device(s) 1622 permit(s) a user to enter data and commands into the processor 1612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1624 are also connected to the interface circuit 1620 of the illustrated example. The output devices 1624 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1620 of the illustrated example, thus, typically includes a graphics driver card, a graphics driver chip or a graphics driver processor.

The interface circuit 1620 of the illustrated example also includes a communication device such as a transmitter, a receiver, a transceiver, a modem and/or network interface card to facilitate exchange of data with external machines (e.g., computing devices of any kind) via a network 1626 (e.g., an Ethernet connection, a digital subscriber line (DSL), a telephone line, coaxial cable, a cellular telephone system, etc.).

The processor platform 1600 of the illustrated example also includes one or more mass storage devices 1628 for storing software and/or data. Examples of such mass storage devices 1628 include floppy disk drives, hard drive disks, compact disk drives, Blu-ray disk drives, RAID systems, and digital versatile disk (DVD) drives.

The coded instructions 1632 of FIGS. 7-13 may be stored in the mass storage device 1628, in the volatile memory 1614, in the non-volatile memory 1616, and/or on a removable tangible computer readable storage medium such as a CD or DVD.

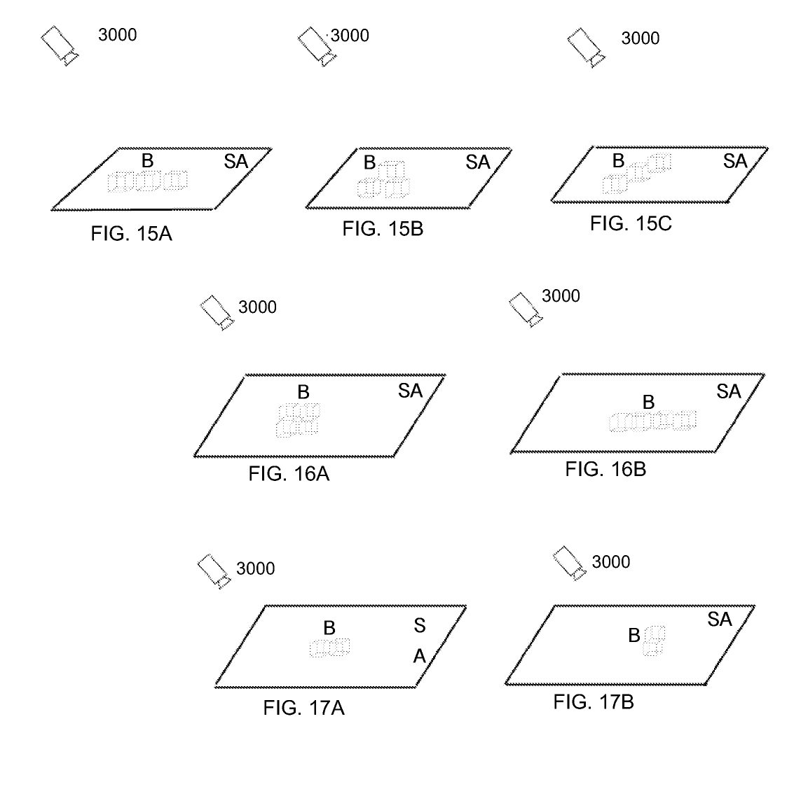

An additional example of the disclosed use of image-based state identification of a process is depicted in FIGS. 15A-C, 16A-B, and 17A-B, in which a camera system 3000 is used to monitor the process of the flow of articles through a facility, such as a manufacturing plant, warehouse, distribution center, etc. As articles move through such a facility, there are typically collection or storage points for the articles where they are accumulated before further processing. For example, the articles may be boxes of finished goods that are being delivered to and held in a staging area before being loaded onto a trailer for shipment. In some examples, information about these boxes, such as the number of boxes or their density in the staging area may be indicative of the state of the operation within the facility. For example, the desired (e.g., optimal) number of boxes, or the desired (e.g., optimal) box density in a given area, may represent a first state. Similarly, a large number of boxes (e.g., above a certain threshold), or a high density thereof being present in the staging area may correspond to a second state. In some examples, such a state may be an indication that the plant is producing finished goods faster than they can be loaded onto trailers. If this is known, in some examples, corrective action can be taken to address this issue—such as slowing down production, getting additional personnel involved in the loading process, or redirecting the finished goods to a different storage area where an over-accumulation is not occurring. A third state may correspond to the number or density of boxes falling below a certain threshold. In some examples, the third state could indicate that the production of goods is too slow, suggesting the corrective action of increasing the rate of production.

FIGS. 15A-C depict the camera system 3000 monitoring a staging area SA to determine a relevant parameter about boxes B being held within that area—such as the density of boxes B within that area (e.g., number of boxes per unit area). For ease of illustration, the camera system 3000 of the illustrated example has been depicted by just a symbol for a camera, but this representation should be construed to include other optional components to make up the system 3000, such as a processor for running video analytics logic (e.g., software), a video storage device, and communication components to allow the system to communicate with another system controlling the process being monitored—such as a WMS (warehouse management system) used to control logistics flow in a manufacturing or warehousing facility. FIG. 15A shows an example of the operational process of the facility being in a first state, such as a normal or desired (e.g., optimal) state, in which three boxes are present in the staging area, thus representing a box density of 3. FIGS. 15B and C show other examples of a box density of 3, but with the boxes being in differing orientations. FIGS. 16A and B show two examples of the process being in a second or high density state in which the box density is 4, which might represent on over-accumulation situation. FIGS. 17A and B show the process in a third or low density state in which the box density is 2, which might represent an under-accumulation situation. Various other locations and orientations of boxes in each of the three states are also possible. Even so, the three states of box density in the illustrated examples are distinct enough from each other that image-based state identification can be used to determine which of the states the process is in.

As in the previous examples, the camera system 3000 is trained to identify and distinguish between the three states depicted in FIGS. 15A-C, 16A-B, and 17A-B. For that purpose, in some examples, images of the staging area are first assembled which depict the staging area in at least the three states of interest. In some such examples, the images are then analyzed (for example by a human operator) to identify images representing examples of the three different states. In such examples, these images, once properly identified and categorized as examples of the various states, represent a “training set” that is presented to the video analytics of the camera system 3000. The analytics then “learns” the features associated with each state of the process. In some examples, once the analytics has “learned” the features of each process state, it is then capable of analyzing new images and, based on its training, assigning that image to a given process state (e.g. normal, high, and low density states such as a box density of 3, 4 or 2, respectively), for example by assigning a confidence level that a particular image represents a given process state. In some examples, the state identification information may then be communicated by the camera system 3000 to control the process. For example, the camera system may communicate the box density in the staging area to a WMS that uses this information to adjust the logistics flow in the facility.

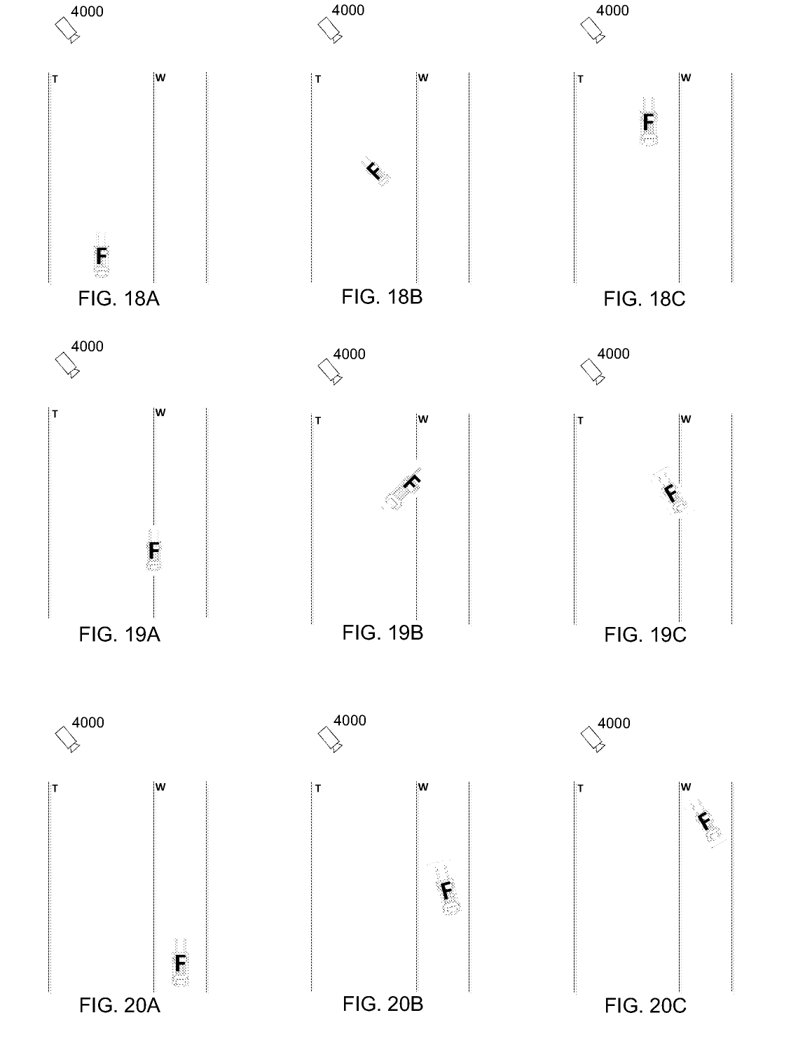

A still further example of the disclosed use of image-based state identification of a process is depicted in FIGS. 18A-C, 19A-C, and 20A-C, in which a camera system 4000 is used to monitor the process of vehicle movement through a facility such as a warehouse. In many facilities, industrial vehicles such as forktrucks are required to only drive or be stationary within specified traffic lanes. Similarly, pedestrians are often restricted to walking or standing in specified walkways. These requirements are in place to minimize the potential for dangerous interactions, such as collisions, between forktrucks and pedestrians. The illustrated examples show a forktruck F, a forktruck traffic lane T and a pedestrian walkway W in addition to a camera system 4000. FIGS. 18A-C represent three examples of a first process state, such as a normal state, in which forktruck F is properly moving within the traffic lane T. FIGS. 19A-C represent three examples of a second process state, such as an encroachment state, in which the forktruck is partially encroaching into the walkway W. FIGS. 20A-C represent three examples of a third process state, such as a penetration state, in which forktruck F is fully within walkway W. These three example states are distinct enough from each other that image-based state identification can be used to determine which of the states the process is in, and thus whether the forktruck F is properly adhering to the requirement that it stay within the traffic lane.

As in the previous examples, the camera system 4000 is trained to identify and distinguish between the three states depicted in FIGS. 18A-C, 19A-C, and 20A-C. For that purpose, in some examples, images of the forktruck F traffic lane T and walkway W are first assembled which depict the area of interest in at least the three states of interest. In some such examples, the images are then analyzed (for example by a human operator) to identify images representing examples of the three different states (e.g., normal, encroachment, and penetration). In such examples, these images, once properly identified and categorized as examples of the various states, represent a “training set” that is presented to the video analytics of the camera system 4000. The analytics then “learns” the features associated with each state of the process. In some examples, once the analytics has “learned” the features of each process state, it is then capable of analyzing new images and, based on its training, assigning that image to a given process state (e.g., normal, encroaching, penetrating), for example by assigning a confidence level that a particular image represents a given process state.

In some examples, the state identification performed by the camera system 4000 can be used in a variety of ways to control the process according to the disclosure herein. For example, the camera system 4000 may compile a log of encroachment events such as depicted in FIGS. 19A-C and/or full penetration events as depicted in FIGS. 20A-C. In this situation, the camera system 4000 is provided with video storage capabilities as would allow, for example, a supervisor to periodically review this log of events and take corrective action to improve the process. For example, if a particular forktruck F has a higher frequency of encroachments into the walkway than another forktruck, the corrective action may be additional training for the forktruck operator with higher frequency. In the case of full penetration events, the corrective action may be disciplinary action for the offending forktruck operator. The previous examples represent what could be referred to as “indirect” control of the vehicle movement process, but more direct control is also possible. For example, providing the camera system with communication capability would allow a warning (visual, audible, etc.) to be generated whenever the camera system 4000 determines that the process is in the encroachment state depicted in FIGS. 19A-C—with the aim of notifying the forktruck operator to change his trajectory away from the walkway W and/or warning any pedestrians in the walkway W that a forktruck may be approaching. In some examples, the camera system 4000 may also be programmed to ignore “incidental” encroachment of a forktruck F in the walkway W. In some such examples, the system 4000 would be programmed to log such encroachment states for a specified time period—for example an 8-hour shift. If there are less than, say five encroachments during that time (suggesting that the encroachments were only incidental and not indicative of a more systemic problem), the camera system 4000 only logs those events but is not programmed to take other action. If however, the number of encroachments exceeds that threshold within the 8-hour window, other action is taken—such as the camera system 4000 sending a notification to a supervisor with the number of encroachments. With the camera system 4000 having video storage and replay capabilities and/or video event logging as described above, the supervisor could then review the encroachment events and take appropriate corrective action. Other examples of use of the disclosed image-based state identification to control the process being monitored are also possible.

Although certain example methods, apparatus and articles of manufacture have been described herein, the scope of the coverage of this patent is not limited thereto. On the contrary, this patent covers all methods, apparatus and articles of manufacture fairly falling within the scope of the appended claims either literally or under the doctrine of equivalents.

1-25. (canceled)

26. A state identification method for monitoring a process characterized by at least two states, comprising:
obtaining a first set of images of the process;
identifying from the first set of images reference images that correspond to each of the at least two states;
obtaining at least one analysis image of the process that is being monitored;
comparing the analysis image to the reference images by digital analysis; and
determining whether the analysis image corresponds to one of a first state of the at least two states or a second state of the at least two states.

27. The method of claim 26, further comprising controlling the process based on the determination of the correspondence of the analysis image.

28. The method of claim 26, further comprising:
assembling a first set of training images corresponding to the first state;
assembling a second set of training images corresponding to the second state; and
presenting the first and second sets of training images to digital analysis software running on a computing device, the digital analysis software to distinguish and retain differences between the first set of training images and the second set of training images.

29. The method of claim 28, wherein comparing the analysis image to the reference images comprises the digital analysis software using the differences between the first and second sets of training images.

30. The method of claim 26, further comprising recording video of the process.

31. The method of claim 30, further comprising tagging the video with information indicative of whether the process was in one of the first state or the second state.

32. The method of claim 31, wherein tagging the video comprises logging at least one event in a video event log, wherein the at least one event comprises at least one video frame that has been determined to correspond to one of the first state or the second state.

33. The method of claim 32, wherein the at least one event comprises other video frames before and after the at least one video frame.

34. The method of claim 32, wherein the video event log comprises a plurality of logged events associated with the process.

35. The method of claim 34, further comprising performing mathematical analysis on at least one parameter associated with the plurality of logged events in the video event log.

36. The method of claim 35, wherein the at least one parameter is a frequency related to the plurality of events.

37. The method of claim 30, further comprising:
comparing another analysis image to the reference images by digital analysis before the comparison of the analysis image;
determining whether the other analysis image corresponds to one of the first state or the second state;
receiving human-based feedback corresponding to the success or failure of the determination of the correspondence of the other analysis image; and
using the human-based feedback in at least one of the comparison of the analysis image to the reference images or the determination of the correspondence of the analysis image.

38. The method of claim 37, wherein the human-based feedback comprises a tag associated with the video, the tag comprising an indication that the other analysis image was determined to correspond to one of the first state when the process was not in the first state or the second state when the process was not in the second state.

39. The method of claim 38, wherein the tag corresponds to a false alarm event in a video event log, wherein the false alarm event comprises at least one video frame corresponding to the other analysis image that was incorrectly determined to correspond to one of the first state or the second state.

40. The method of claim 37, wherein the human-based feedback comprises a tag associated with the video, the tag comprising an indication that the other analysis image was not determined to correspond to one of the first state when the process was in the first state or the second state when the process was in the second state.

41. The method of claim 40, wherein the tag corresponds to a missed detection event in a video event log, wherein the missed detection event comprises at least one video frame corresponding to the other analysis image that was determined not to correspond to one of the first state when the process was in the first state or the second state when the process was in second state.

42. The method of claim 26, wherein the process comprises conveying of articles, and the first state corresponds to a normal flow of the articles and the second state corresponds to when one or more of the articles being jammed while being conveyed.

43. The method of claim 27, wherein the process comprises conveying of articles, and the first state corresponds to a normal flow of the articles and the second state corresponds to one or more of the articles jamming while being conveyed.

44. The method of claim 43, further comprising stopping the conveyance of additional articles when the process is in the second state.

45. The method of claim 27, wherein the process comprises conveying articles along a conveyor, and the first state corresponds to a pre-jam state and the second state corresponds to when one or more of the articles are jammed on the conveyor.

46. The method of claim 45, further comprising slowing down the conveyance of additional articles when the analysis image is determined to correspond to the first state.

47. The method of claim 26, wherein the process comprises an accumulation of articles at a collection point, the first state corresponding to a number or a density of the articles at the collection point being below a threshold, and the second state corresponds to a number or a density of the articles at the collection point that equals or exceeds the threshold.

48. The method of claim 26, wherein the process comprises vehicle movement, the first state corresponding to a vehicle travelling within a designated traffic lane, the second state corresponding to the vehicle moving at least partially outside of the designated traffic lane.

49. The method of claim 27, wherein at least one of the first state or the second state corresponds to a human interacting with the process, and upon determination that the process is in the second state, controlling the process to reduce potential contact with the human.

50. The method of claim 49, wherein controlling the process to reduce the potential contact comprises stopping the process.

51-78. (canceled)

79. A jam detection method for monitoring a machine that might experience at least one of a first state or a jam state associated with handling an article, comprising:
obtaining a first set of images of machine operation;
identifying from the first set of images reference images that correspond to the first state and the jam state;
obtaining at least one analysis image of operation of the machine;
comparing the analysis image to the reference images by digital analysis; and
determining whether the analysis image corresponds to one of the first state or the jam state.

80-86. (canceled)

87. A machine monitoring system, comprising:
a camera to capture video of at least a portion of a machine;
a video storage device to store at least a portion of the video, the video storage device capable of creating an event log associated with the stored video;
a signal source to generate a signal indicative of a status of machine operation; and
a communication interface in communication with the video storage device and the signal source, wherein the communication interface is to respond to the signal from the signal source by instructing the video storage device to create an entry in the event log corresponding to a status of the machine operation indicated by the signal.

88-100. (canceled)
